(19) United States
(12) Patent Application Publication
(10) Pub. No.: US 2025/0134190 A1
(43) Pub. Date: May 1, 2025

(54) Glove Attachment For Wire Sheathing Cleanup

(71) Applicant: Alton Wallace, Woodbridge, VA (US)

(72) Inventor: Alton Wallace, Woodbridge, VA (US)

(21) Appl. No.: 18/494,297

(22) Filed: Oct. 25, 2023

(51) Int. Cl. A41D 19/00; H02G 1/12

(52) U.S. Cl. CPC A41D 19/0024; H02G 1/12; A41D 2600/20

(57) ABSTRACT

The device for wire sheathing cleanup attaches to the back of the hand and is connected to a glove. A holding reservoir is located on the back of the pointer finger. When the wire is sheathed, the pointer finger and reservoir is located underneath the sheathing. The sheathing falls into the reservoir and eventually slides into the container located on the back of the hand. The wire sheathing cleanup device comprises of four separate raceways that when the pointer finger is straightened makes one continuous raceway to the final container. This device then allows the user to collect the stripped ends of electrical wires without needing to pick up the sheathed ends after the job is done.

### BACKGROUND OF THE INVENTION

Sheathing wires is the process by which the insulation on the outside of a wire is removed. This removal process causes the outside covering of the wire to fall to the ground and cause a mess. The present subject matter is meant to prevent this cleanup.

### SUMMARY OF THE INVENTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The present subject matter attaches to the back of the hand and is connected to a glove. A funnel shaped holding reservoir is located on the back of the pointer finger. When the wire is sheathed, the pointer finger and reservoir is located underneath the sheathing. The sheathing falls into the reservoir and eventually slides into the container located on the back of the hand.

The present subject matter comprises of four separate pivotally connected raceways that when the pointer finger is straightened makes one continuous raceway to the final container. This device then allows the user to collect the stripped ends of electrical wires without needing to pick up the sheathed ends after the job is done.

In some embodiments, the device connects directly to the hand instead of a glove. In other embodiments, the device may comprise of one continuous raceway.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation.

The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom.

### BRIEF DESCRIPTION OF DRAWINGS

FIG. 1 shows a perspective view of an electrical wire being sheathed with the device attached to a glove.

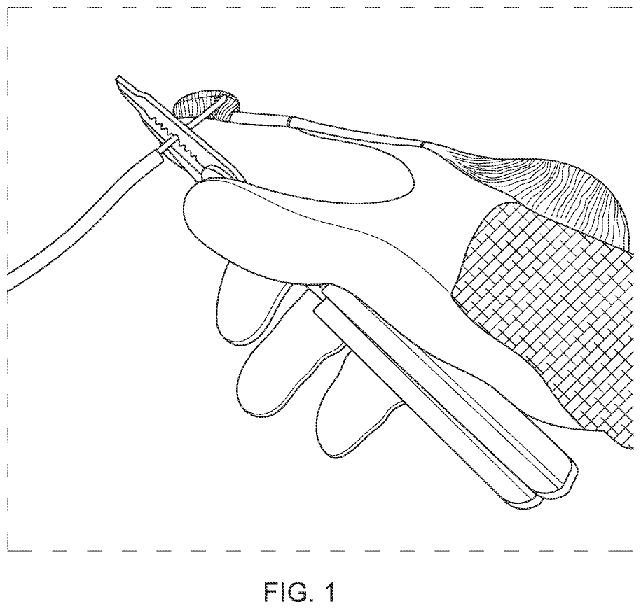

FIG. 2 shows a top view of the device attached to a glove with each raceway aligned.

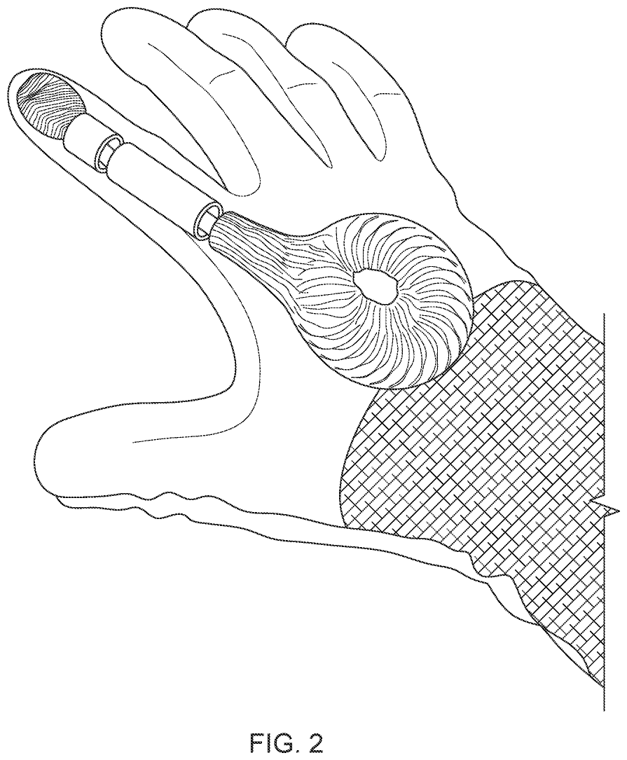

FIG. 3 shows a side view of the device attached to a glove with the pointer finger bent.

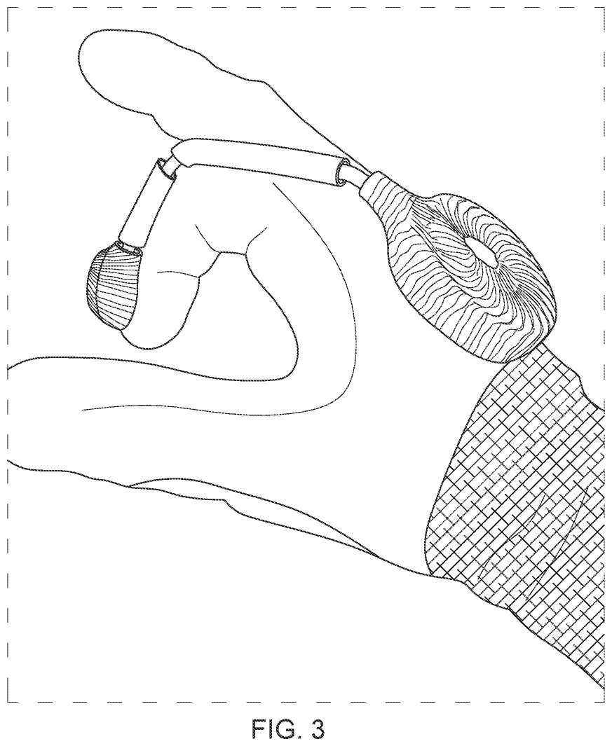

FIG. 4 shows a top view of the device attached to a glove with each raceway aligned.

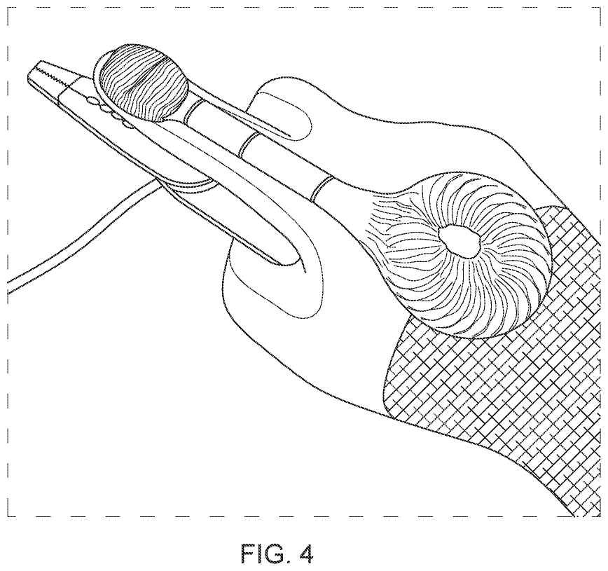

1. A glove attachment for wire sheathing cleanup comprising of a glove, a reservoir, four raceways, and a container.

2. The glove attachment for wire sheathing cleanup comprising of the glove, the reservoir, four raceways, and the container as in claim 1, wherein the reservoir has a funnel shape to facilitate capturing sheathed wire ends.

3. The glove attachment for wire sheathing cleanup comprising of the glove, the reservoir, four raceways, and the container as in claim 1, wherein the reservoir is located on the back tip of the pointer finger.

4. The glove attachment for wire sheathing cleanup comprising of the glove, the reservoir, four raceways, and the container as in claim 1, wherein the four raceways are pivotally connected along the pointer finger to the container.

5. The glove attachment for wire sheathing cleanup comprising of the glove, the reservoir, four raceways, and the container as in claim 1, wherein the four raceways become one continuous raceway when the user's finger is straightened.

6. The glove attachment for wire sheathing cleanup comprising of the glove, the reservoir, four raceways, and the container as in claim 1, wherein the container is located on the back of the hand.

7. The glove attachment for wire sheathing cleanup comprising of the glove, the reservoir, four raceways, and the container as in claim 1, wherein the container fills up with wire sheathing each time the pointer finger is straightened to form a continuous raceway.

8. A method of manufacturing a glove attachment for wire sheathing cleanup comprising of a glove, a reservoir, four raceways, and a container.

9. The method of manufacturing the glove attachment for wire sheathing cleanup comprising of the glove, the reservoir, four raceways, and the container as in claim 8, wherein the reservoir has a funnel shape to facilitate capturing sheathed wire ends.

10. The method of manufacturing the glove attachment for wire sheathing cleanup comprising of the glove, the reservoir, four raceways, and the container as in claim 8, wherein the reservoir is located on the back tip of the pointer finger.

11. The method of manufacturing the glove attachment for wire sheathing cleanup comprising of the glove, the reservoir, four raceways, and the container as in claim 8, wherein the four raceways are pivotally connected along the pointer finger to the container.

12. The method of manufacturing the glove attachment for wire sheathing cleanup comprising of the glove, the reservoir, four raceways, and the container as in claim 8, wherein the four raceways become one continuous raceway when the user's finger is straightened.

13. The method of manufacturing the glove attachment for wire sheathing cleanup comprising of the glove, the reservoir, four raceways, and the container as in claim 8, wherein the container is located on the back of the hand.

14. The method of manufacturing the glove attachment for wire sheathing cleanup comprising of the glove, the reservoir, four raceways, and the container as in claim 8, wherein the container fills up with wire sheathing each time the pointer finger is straightened to form a continuous raceway.
